(19) United States
(12) Patent Application Publication
(10) Pub. No.: US 2026/0074401 A1
(43) Pub. Date: Mar. 12, 2026

(54) METHOD OF PRECHARGING SECONDARY BATTERY AND METHOD OF MANUFACTURING SECONDARY BATTERY EMPLOYING THE PRECHARGING

(71) Applicant: SAMSUNG SDI CO., LTD., Yongin-si (KR)

(72) Inventors: Misun LEE, Yongin-si (KR); Byeongryeol LEE, Yongin-si (KR); Daesung RO, Yongin-si (KR)

(21) Appl. No.: 19/319,892

(22) Filed: Sep. 5, 2025

(30) Foreign Application Priority Data
Sep. 12, 2024 (KR) 10-2024-0125144
Sep. 30, 2024 (KR) 10-2024-0133289

(51) Int. Cl. H01M 50/609; H01M 4/04; H01M 10/04; H01M 50/103; H01M 50/15; H01M 50/169; H01M 50/55

(52) U.S. Cl. CPC H01M 50/609; H01M 4/0445; H01M 10/049; H01M 50/103; H01M 50/15; H01M 50/169; H01M 50/55

(57) ABSTRACT

A method of manufacturing a secondary battery, the method including providing a battery can with an opening and a terminal-side surface, the terminal-side surface including a terminal, providing a cover, the cover being bonded onto the opening of the battery can, assembling an electrode assembly, accommodating the electrode assembly in the battery can and mounting the same, such that the electrode assembly faces the opening, injecting an electrolyte into the battery can within which the electrode assembly is accommodated, pressurizing and precharging the electrode assembly, and bonding the cover onto the opening of the battery can.

### CROSS-REFERENCE TO RELATED APPLICATIONS

The present application claims priority to and the benefit of Korean Patent Applications No. 10-2024-0125144 filed on Sep. 12, 2024 and No. 10-2024-0133289 filed on Sep. 30, 2024, in the Korean Intellectual Property Office, the entire disclosures of which are incorporated herein by reference.

### BACKGROUND

### 1. Field

The present disclosure relates to a method of precharging a secondary battery and a method of manufacturing a secondary battery employing the precharging.

### 2. Description of Related Art

Unlike primary batteries that cannot be charged, secondary batteries are batteries that can be charged and discharged. Generally, a secondary battery includes an electrode assembly including a positive electrode plate, a negative electrode plate, and a separator, and an exterior material (battery can or case) for accommodating the electrode assembly. The electrode assembly may be classified as a rolled type electrode assembly and a stacked type electrode assembly according to a stacking of the electrode plates and the separator. A rolled type is referred to as a jelly-roll type electrode assembly and a stack type is referred to as a stacked type electrode assembly. In addition, secondary batteries may be classified as pouch-type, cylindrical, and prismatic type secondary batteries according to a material and a shape of an exterior material.

The above information disclosed in this Background section is for enhancement of understanding of the background of the present disclosure, and therefore, it may contain information that does not constitute a related (or prior) art.

### SUMMARY

Embodiments include a method of manufacturing a secondary battery, the method including providing a battery can with an opening and a terminal-side surface on which is a terminal, providing a cover, the cover being bonded onto the opening of the battery can, assembling an electrode assembly, accommodating the electrode assembly in the battery can and mounting the same, the electrode assembly facing the opening, injecting an electrolyte into the battery can within which the electrode assembly is accommodated, pressurizing and precharging the electrode assembly, and bonding the cover onto the opening of the battery can.

Providing the battery can may include forming the opening at a surface orthogonal to the terminal-side surface of the battery can.

Providing the battery can my include forming the opening opposite to the terminal-side surface of the battery can.

Injecting the electrolyte includes injecting the electrolyte through the opening of the battery can.

Providing the battery can may include forming an electrolyte inlet in the battery can, and injecting the electrolyte may include injecting the electrolyte through the electrolyte inlet of the battery can.

The method may further include, after bonding the cover onto the opening of the battery can, additionally injecting an electrolyte through the electrolyte inlet formed in the battery can.

Pressurizing and precharging the electrode assembly may include pressurizing, by a pressurization jig, the electrode assembly exposed through the opening while charging the electrode assembly accommodated in the battery can by supplying power.

The pressurization jig may be configured to downward pressurize the electrode assembly horizontally placed.

The method may further include inserting the pressurization jig into a space between the electrode assembly and the battery can.

The pressurization jig may include a protection pad attached to a surface in contact with the electrode assembly.

The protection pad may have different thicknesses according to positions on an electrode plate of the electrode assembly.

The method may further include injecting a fluid to expand the protection pad.

Pressurizing and precharging the electrode assembly may include heating the electrode assembly.

The method may further include, after pressurizing and precharging the electrode assembly, additionally injecting an electrolyte into the battery can.

Embodiments include a method of precharging a secondary battery, the method including providing an electrode assembly, providing a battery can with an opening and accommodating the electrode assembly in the battery can, the electrode assembly facing the opening, injecting an electrolyte into the battery can with the electrode assembly accommodated in the battery can, and pressurizing and precharging the electrode assembly.

Pressurizing and precharging the electrode assembly may include pressurizing, by a pressurization jig, the electrode assembly exposed through the opening while charging the electrode assembly accommodated in the battery can by supplying power.

Pressurizing and precharging the electrode assembly may include heating the electrode assembly.

A secondary battery manufactured by the method of manufacturing, the secondary battery including, a battery can with an opening and a terminal-side surface, a terminal being on the terminal-side surface, in which an electrode assembly is accommodated therein, and a cover being bonded onto the opening of the battery can.

The opening may be at a surface orthogonal to the terminal-side surface of the battery can.

The opening may be opposite to the terminal-side surface of the battery can.

Aspects and features of the present disclosure are not limited to those described above, and other aspects and features not specifically mentioned herein will be clearly understood by those of ordinary skill in the art from the description of the present disclosure below.

### BRIEF DESCRIPTION OF THE DRAWINGS

Features will become apparent to those of ordinary skill in the art by describing in detail exemplary embodiments with reference to the attached drawings, in which:

FIGS. 1 and 2 are schematic diagrams illustrating an electrode assembly of a secondary battery according to some embodiments of the present disclosure;

FIG. 3A is a top perspective view illustrating an exterior of a prismatic secondary battery according to some embodiments of the present disclosure;

FIG. 3B is a top perspective view illustrating an exterior of a prismatic secondary battery according to some other embodiments;

FIGS. 4A and 4B are exploded perspective views illustrating the prismatic secondary battery shown in FIG. 3, wherein FIG. 4A shows a case in which the electrode assembly of FIG. 1 is applied, and FIG. 4B shows a case in which the electrode assembly of FIG. 2 is applied;

FIG. 5 is a process flowchart illustrating a method of manufacturing a secondary battery to which secondary battery precharging is applied according to some embodiments of the present disclosure;

FIGS. 6 to 9 are side cross-sectional views illustrating a secondary battery for describing each process of FIG. 5;

FIG. 10 is a process flowchart illustrating a method of manufacturing a secondary battery to which secondary battery precharging is applied according to some other embodiments of the present disclosure;

FIGS. 11A and 11B are process flowcharts illustrating a method of manufacturing a secondary battery to which secondary battery precharging is applied according to still other embodiments of the present disclosure;

FIGS. 12A and 12B are exploded perspective views illustrating two embodiments of prismatic secondary batteries applicable to the present disclosure;

FIG. 13 is a process flowchart illustrating a method of manufacturing a secondary battery to which secondary battery precharging is applied according to some embodiments of the present disclosure;

FIGS. 14 to 17 are diagrams illustrating a secondary battery for describing each process of FIG. 13;

FIGS. 18A to 18F diagrams showing the pressurization jig according to various embodiments;

FIG. 19 is a process flowchart illustrating a method of manufacturing a secondary battery to which secondary battery precharging is applied according to some other embodiments of the present disclosure;

FIGS. 20A and 20B are process flowcharts illustrating a method of manufacturing a secondary battery to which secondary battery precharging is applied according to still other embodiments of the present disclosure;

FIG. 21 is an exemplary diagram illustrating a secondary battery module in which secondary batteries employing the electrode assembly manufactured according to the present disclosure are disposed;

FIG. 22 is an exemplary diagram illustrating a secondary battery pack formed to apply the secondary battery module shown in FIG. 21 to a product; and

FIG. 23 is a diagram illustrating a vehicle in which the secondary battery pack shown in FIG. 22 is embedded.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of” A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, s, operations, elements, and/or components but do not preclude the presence or addition of one or more other features, integers, s, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

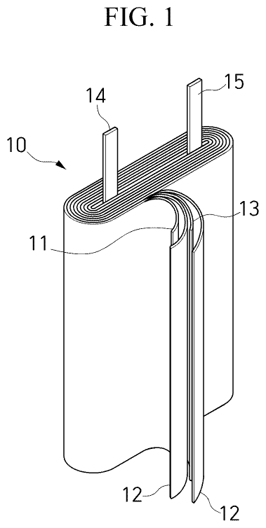

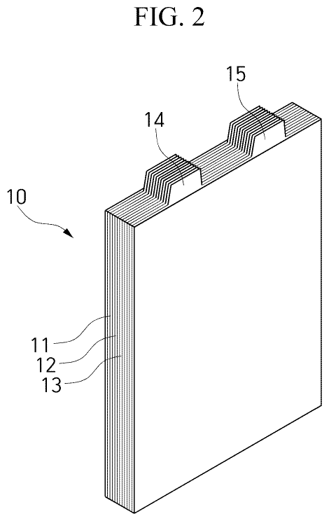

FIG. 1 and FIG. 2 schematically illustrate an electrode assembly of a secondary battery according to some embodiments of the present disclosure. FIG. 1 illustrates a wound-type electrode assembly, and FIG. 2 illustrates a stacked type electrode assembly.

As shown, an electrode assembly 10 may be formed by winding or stacking a stack of a first electrode plate 11, a separator 12, and a second electrode plate 13, each of which are formed as thin plates or films. When the electrode assembly 10 is a wound type, a winding axis may be parallel to the longitudinal direction of a case. In other embodiments, the electrode assembly 10 may be a stacked type rather than a wound type, and the shape of the electrode assembly 10 may vary. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case may vary. The first electrode plate 11 of the electrode assembly may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

In some embodiments, the electrode assembly 10 may be accommodated in a case along with an electrolyte. In a pouch-type secondary battery, an electrode assembly 10 may be accommodated in a pouch made of flexible material. In a cylindrical or prismatic secondary battery, an electrode assembly 10 may be accommodated in a cylindrical or prismatic metal casing.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5. 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof, X is Al, Ni, Co, Mn, Cr, Fe, Mg, Sr, V, a rare earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but the substrate material may vary.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x≤2), a Si alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but may vary.

The organic material and the inorganic material may be mixed in one coating layer or may be in the form of a coating layer including (or containing) an organic material and a coating layer including (or containing) an inorganic material that are stacked on each other.

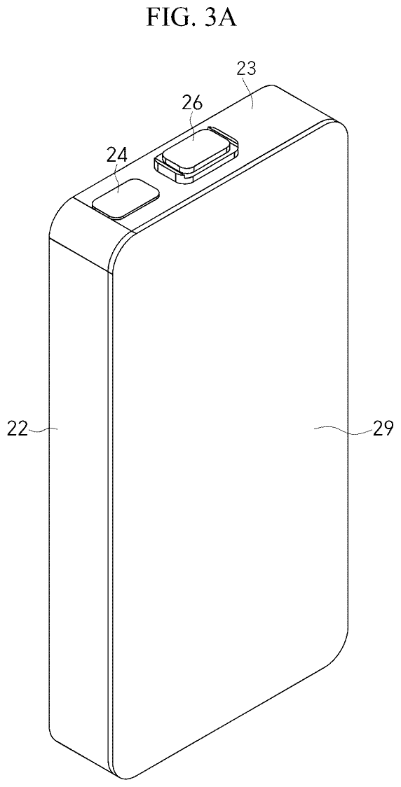

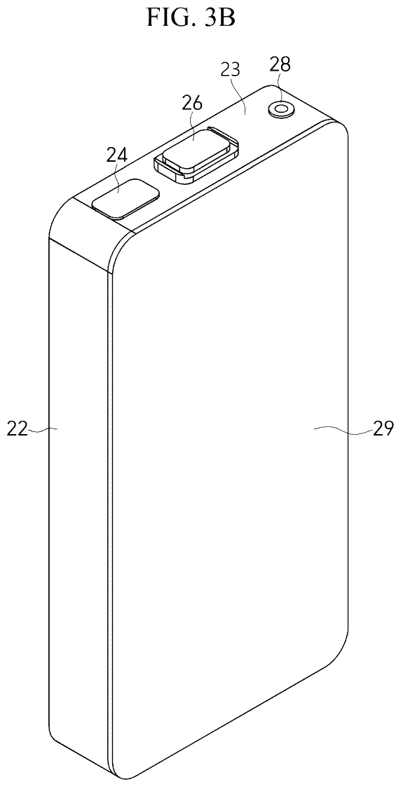

FIG. 3A is a top perspective view illustrating an exterior of a prismatic secondary battery according to some embodiments of the present disclosure. FIG. 3B is a top perspective view illustrating an exterior of a prismatic secondary battery according to some other embodiments.

A battery can 22 may provide a space in which the electrode assembly 10 shown in FIG. 1 is accommodated and may form the entire exterior of the secondary battery. The battery can 22 may be made of a conductive metal such as stainless steel (SUS), aluminum, aluminum alloy, or nickel-plated steel.

A first terminal 24 and/or a second terminal 26 may be installed on a terminal-side surface 23 to be electrically connected to a first electrode tab 14 and a second electrode tab 15 of the electrode assembly 10 accommodated inside the battery can 22, respectively, thereby being exposed to the outside of the battery can 22. In addition, a vent, which is opened by a gas generated inside the battery to degas the gas, may be formed at an arbitrary position on the battery can 22.

In an example of FIG. 3A, since an inlet for injecting an electrolyte into battery can 22 is not formed separately, in order to inject the electrolyte into the battery can 22, the electrolyte should be injected in advance before a cover 29 is sealed. On the other hand, in an example of FIG. 3B, since an electrolyte inlet 28 is formed in the battery can 22, the electrolyte may be injected even after the cover 29 is sealed.

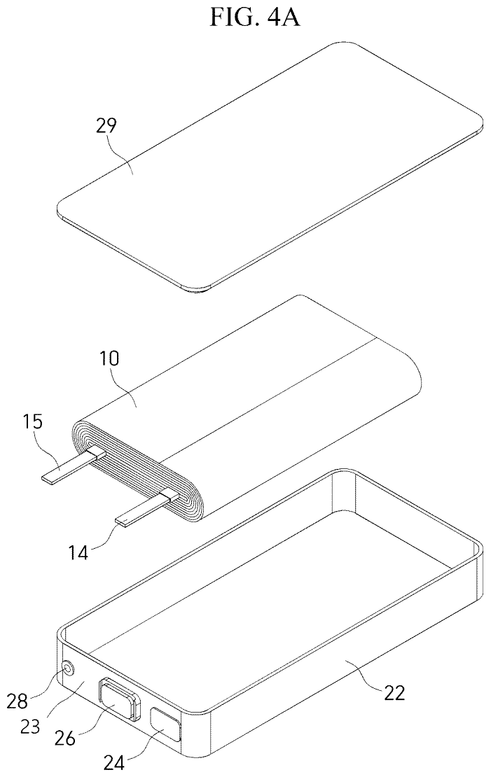

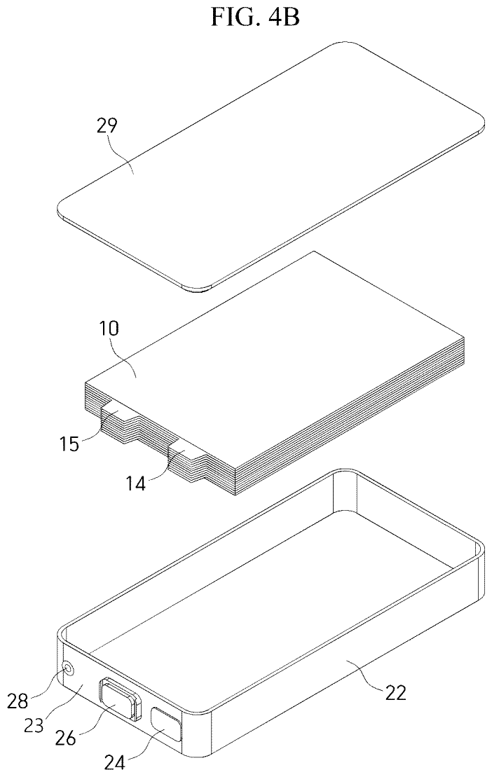

The prismatic secondary battery shown in FIGS. 3A and 3B above may be disassembled as shown in FIG. 4A or FIG. 4B, respectively. FIGS. 4A and 4B are exploded perspective views illustrating the prismatic secondary battery shown in FIG. 3B having the electrolyte inlet 28. FIG. 4A shows a case in which the electrode assembly of FIG. 1 is applied, and FIG. 4B shows a case in which the electrode assembly of FIG. 2 is applied.

The prismatic secondary battery as shown has a structure, in which one of the wide lateral surfaces orthogonal to the terminal-side surface 23 of the battery can 22 is open, the electrode assembly 10 is inserted into the opening, and the cover 29 covers the opening. The first electrode tab 14 and the second electrode tab 15 of the electrode assembly 10 may be connected to the first terminal 24 and the second terminal 26, which are exposed to the outside of the battery can 22, by welding inside the battery can 22.

After the electrode assembly 10 is assembled with the battery can 22 and the cover 29 is sealed, the electrolyte may be injected through the electrolyte inlet 28 and then subsequent processes such as aging and precharging may be performed.

Hereinafter, a state of the secondary battery shown in FIGS. 3A and 3B, i.e., a state in which the external of the first terminal 24 and the second terminal 26 are facing upward, is defined as an “upright state.” In addition, a state in which the secondary battery is reposed as shown in FIGS. 4A and 4B is defined as a “horizontally mounted (or placed) state.”

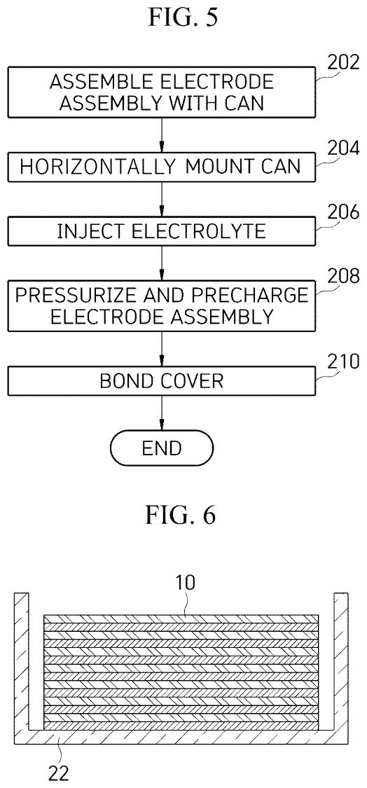

FIG. 5 is a process flowchart illustrating a method of manufacturing a secondary battery having a battery can 22 having the opening in a lateral surface orthogonal to the terminal-side surface 23 such as FIG. 4A or FIG. 4B. In addition, FIGS. 6 to 9 are side cross-sectional views illustrating a secondary battery for describing each process of FIG. 5.

First referring to FIG. 5, as shown in FIGS. 4A and 4B, the battery can 22 with the opening that is open laterally and the cover 29 may be manufactured, the electrode assembly may be accommodated in and assembled with the battery can 22 (202), and the battery may be mounted (or placed) horizontally to allow the opening to face upward (204).

As shown in FIG. 6, the electrode assembly 10 may be accommodated in the battery can 22, and the first electrode tab 14 and the second electrode tab 15 (see FIGS. 1 and 2) of the electrode assembly 10 and the first terminal 24 and the second terminal 26 (see FIG. 3) located outside of the battery can 22 may be assembled by electrically connecting the first electrode tab 14 and the second electrode tab 15 and the first terminal 24 and the second terminal 26, respectively.

The electrolyte may be injected into the battery can with which the electrode assembly is assembled (206).

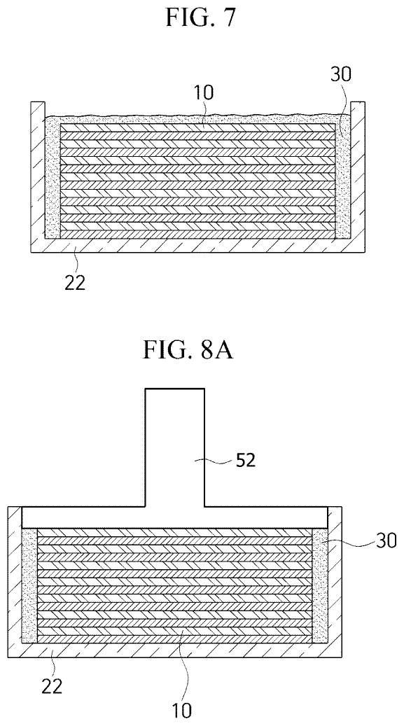

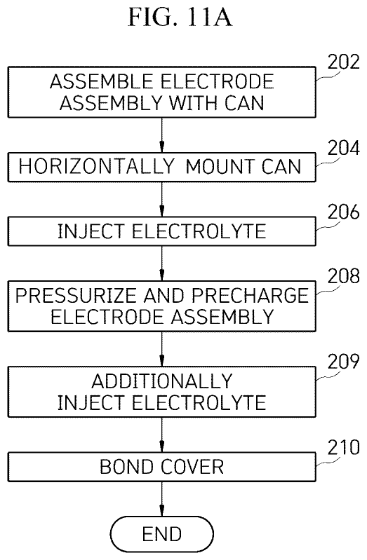

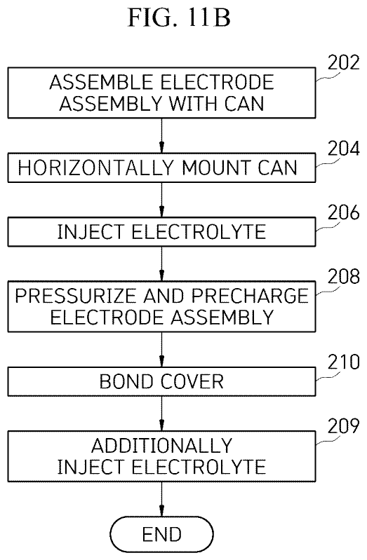

FIG. 7 shows a state in which space between the electrode assembly 10 and the battery can 22 is filled with the electrolyte 30. When a secondary battery is designed, since a volume of the electrode assembly 10 is set to be less than a volume of the battery can (for example, 90%) by considering the processes of inserting the electrode assembly 10 and injecting the electrolyte, the remaining space may be filled with the electrolyte 30. The amount of the electrolyte may be the same as a design amount of the final secondary battery product or may be less than the design amount. When an amount of the electrolyte less than the final amount is injected in this operation, an additional amount of electrolyte may be injected in a subsequent process (see FIGS. 11A and 11B).

In some embodiments (e.g., in the case of FIG. 3A), the injecting of the electrolyte 30 may be performed through the lateral surface opening in the battery can 22. In some other embodiments (e.g., in the case of FIG. 3B), the injection of the electrolyte 30 may be performed through the electrolyte inlet 28 formed in the battery can 22.

The electrode assembly may be pressurized and precharged (208).

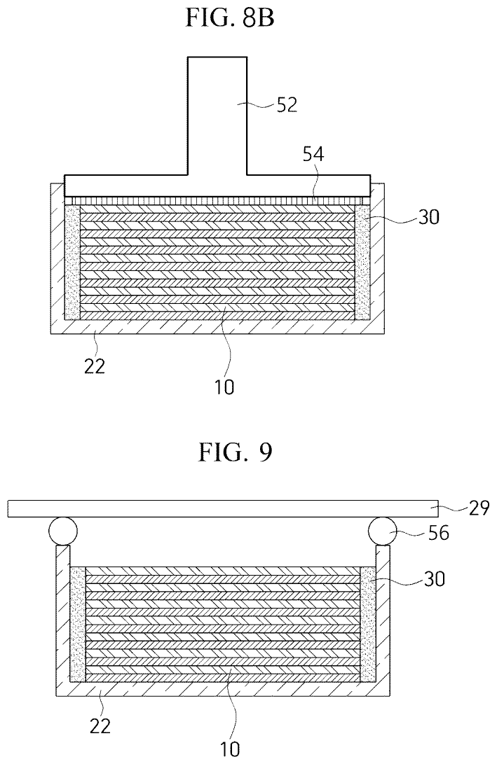

As shown in FIG. 8A, the electrode assembly 10 exposed through the opening of the battery can 22 in a horizontally mounted (or placed) state may be downward pressurized and compressed using a pressurization jig 52. In this case, power is supplied to charge the electrode assembly 10. Here, a pressurization area of the pressurization jig 52 may be large enough to cover the entire side area of the electrode assembly 10. This is to ensure that the electrode plates of the electrode assembly 10 can be pressurized uniformly. Furthermore, the pressurization area of the pressurization jig 52 may be manufactured to be in contact with or close to an inner surface of a side wall of the battery can 22 in addition to the side surface area of the electrode assembly 10. This is to pressurize not only the electrode assembly 10 but also the electrolyte 30 so that the electrolyte 30 may be sufficiently injected between the electrode plates of the electrode assembly 10.

Precharging is a process of precharging the electrode assembly 10 by supplying a predetermined amount of power to the first terminal 24 and the second terminal 26 in FIG. 3A or 3B. During the precharging process, lithium ions move to the negative electrode, react with the electrolyte, and form a solid electrolyte interface (SEI) layer on a surface of the negative electrode.

FIG. 8B shows an example in which a protection pad 54 is attached to a pressurization surface of the pressurization jig 52. The protection pad 54 is for preventing the electrode assembly 10 from being damaged due to pressurization of the pressurization jig 52 and maintaining flatness. The protection pad 54 may be made of silicone or Vulkollan (e.g., a high-performance polyurethan elastomer).

A pressurizing force of the pressurization jig 52 for pressurizing the electrode assembly 10 may range from about 4 kgf to 13 kgf per unit area (e.g., per 1 cm²). That is, the electrode assembly 10 may be pressurized by the pressurizing force of about 4 kgf/cm² to 13 kgf/cm². However, the pressurizing force may vary.

Referring to FIG. 5 again, after the pressurization and the precharging (208) are completed, the cover 29 may be brought into contact with and sealed the opening of the battery can 22.

FIG. 9 shows a state in which the cover 29 is bonded onto the battery can 22. A reference numeral “56” shown in FIG. 9 denotes a welding portion formed by welding. The bonding of the cover 29 may be performed by laser welding, but the bonding may vary. FIG. 9 shows a case in which an area of the cover 29 is greater than an area of the opening of the battery can 22. In this case, after the welding, trimming for cutting and grinding an excess edge of the cover 29 may be required.

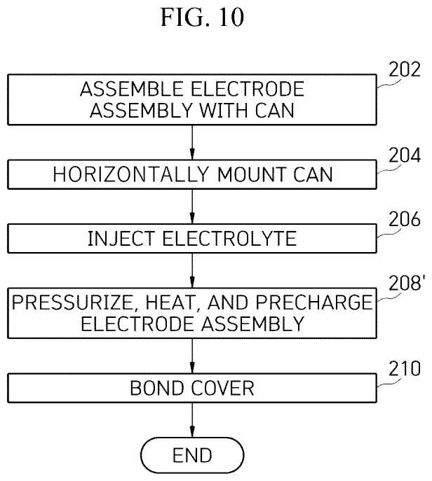

FIG. 10 is a process flowchart illustrating a method of manufacturing a secondary battery to which secondary battery precharging is applied according to some other embodiments of the present disclosure.

In a similar manner to the operation of FIG. 5, an operation of accommodating and assembling the electrode assembly inside the battery can 22 (202), an operation of horizontally mounting the battery can to allow the opening to face upward (204), an operation of injecting an electrolyte (206), and an operation of bonding to the cover (210) may be performed in a similar manner to the embodiment of FIG. 5.

Unlike FIG. 5, a modified process constitutes heating being performed (208′) along with the pressurizing of the electrode assembly while performing the precharging of the electrode assembly. By heating the electrode assembly, activation of the electrolyte and ions may be further promoted to further increase the bonding of the electrode plates and improve charging efficiency.

A heat source for heating the electrode assembly 10 may be included in the pressurization jig 52. In another example, a heating source of the electrode assembly 10 may be included in a support on which the battery can 22 is mounted. In still another example, the heating source of the electrode assembly 10 may be a radiant heat source for directly emitting heat to the electrode assembly 10.

When the pressurizing force of the pressurization jig 52 for pressurizing the electrode assembly 10 ranges from about kgf/cm² to 13 kgf/cm²2, which is the same condition as in the previous case, a heating temperature may range from 0° C. to about 110° C.

FIGS. 11A and 11B are process flowcharts illustrating a method of manufacturing a secondary battery to which secondary battery precharging is applied according to still other embodiments of the present disclosure.

In this case, as described above, an operation of additionally injecting the electrolyte 30 into the battery can 22 (209) may be included after the pressurizing and the precharging are performed.

In the case of FIG. 11A, the operation of additionally injecting an electrolyte (209) may be performed after the pressurizing and the precharging of the electrode assembly (208). Since the operation of additionally injecting the electrolyte (209) is performed before the bonding of the cover (210), the electrolyte may be injected into the opening of the battery can 22, but this may vary. For example, when the electrolyte inlet 28 is formed in the battery can 22 as shown FIG. 3B, the electrolyte may be added additionally through the electrolyte inlet 28.

In the case of FIG. 11B, since the operation of additionally injecting the electrolyte (209) is performed after the bonding of the cover, the electrolyte may be additionally injected through the electrolyte inlet 28 as shown in FIG. 3B.

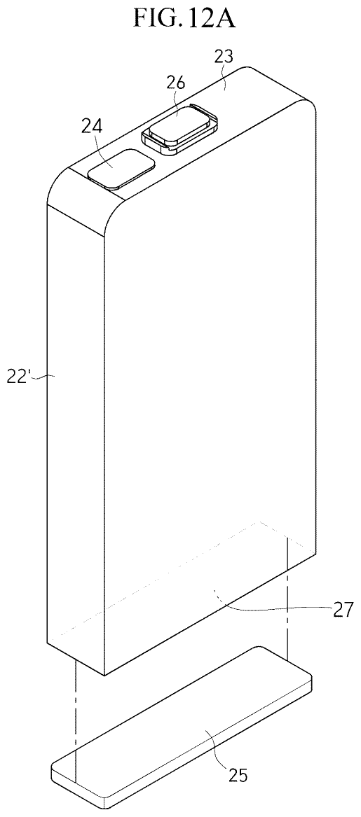

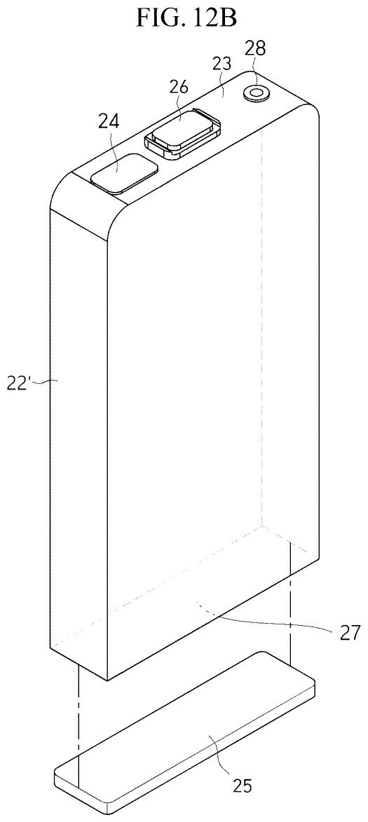

In other embodiments, the prismatic secondary battery shown in FIGS. 3A and 3B above may be disassembled as shown in FIG. 12A or 12B. FIGS. 12A and 12B are exploded perspective views illustrating two embodiments of prismatic secondary batteries applicable to the present disclosure.

The prismatic secondary battery has a structure in which an opening 27 is formed at a position (i.e., a bottom surface) opposite to the terminal-side surface 23 of the battery can 22′, the electrode assembly 10 is inserted into the opening 27, and a cover 25 covers the opening 27. The first electrode tab 14 or the second electrode tab 15 of the electrode assembly 10 may be connected to the first terminal 24 installed on the terminal-side surface 23 inside the battery can 22′ by welding.

In the case of FIG. 12A, since there is no electrolyte inlet, the electrolyte may be injected through the opening 27 at the bottom, and in the case of FIG. 12B, the electrolyte may be injected through the electrolyte inlet 28 or the opening 27 at the bottom.

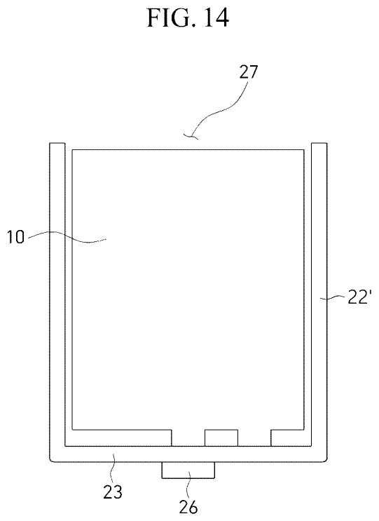

When the state of the secondary battery as shown in FIGS. 12A and 12B, that is, the state in which the terminal-side surface 23 on which the second terminal 26 is installed is positioned upward, is defined as an “upright state,” as shown in FIG. 14, a state in which the secondary battery is placed upside down may be referred to as an “upside-down placement state.” The precharging method of the present disclosure, which will be described below, may be performed in the upside-down placement state of the battery.

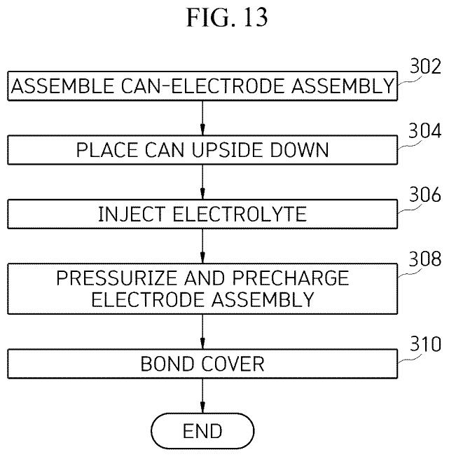

FIG. 13 is a process flowchart illustrating a method of manufacturing a secondary battery having the can 22′ having the opening 27 at the bottom. In addition, FIGS. 14 to 18 are diagrams illustrating description for each process of FIG. 13.

Referring to FIG. 13, as shown in FIGS. 12A and 12B, the battery can 22′ with an opening 27 at a position opposite to the terminal-side surface 23 and the cover 25 are manufactured, and an electrode assembly is accommodated and assembled inside the battery can 22′ (302). Then, the battery can is placed upside-down to allow the opening 27 upward (304).

As shown in FIG. 14, one of the first electrode tab 14 and the second electrode tab 15 (see FIGS. 1 and 2) of the electrode assembly 10 may be connected to the second terminal 26 positioned on the terminal-side surface 23 of the battery can 22′ through the opening 27 on the bottom inside the battery can 22′, the other one may be electrically connected to the battery can 22′, and the electrode assembly 10 may be inserted to assemble a secondary battery.

An electrolyte is injected into the opening 27 of the battery can assembled with the electrode assembly (306).

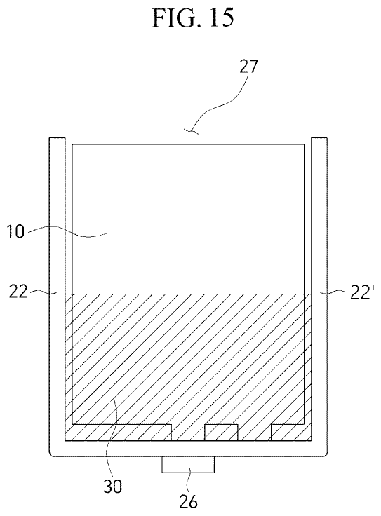

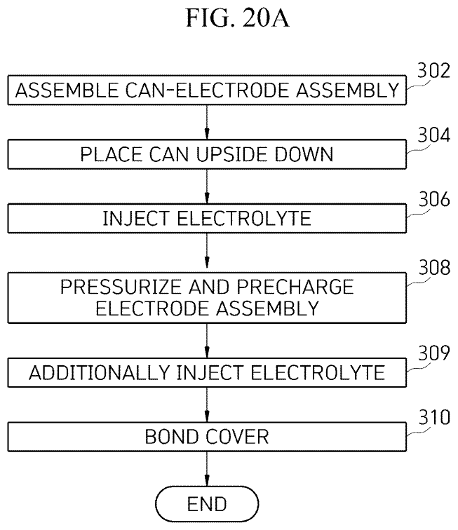

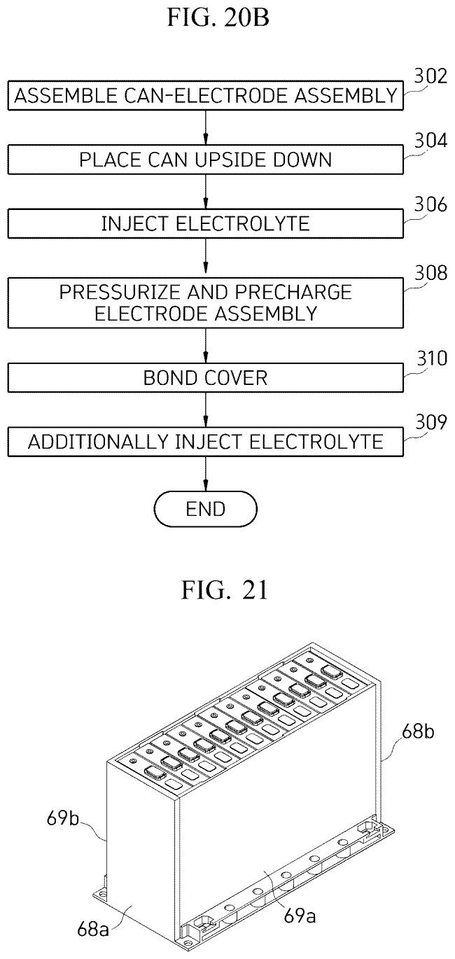

FIG. 15 shows a state in which space between the electrode assembly 10 and the battery can 22′ is filled with an electrolyte 30 injected into through the opening 27 on the bottom. Since a volume of the electrode assembly 10 is set to be less than a volume of the battery can 22′ (for example, 90%) by considering the processes of inserting the electrode assembly 10 and injecting the electrolyte when a secondary battery is designed, the remaining space may be filled with the electrolyte 30. The amount of the electrolyte may be the same as a design amount of the final secondary battery product or may be less than the design amount. When an amount of the electrolyte less than the final amount is injected in this operation, an additional amount of electrolyte may be injected in a subsequent process (see FIGS. 20A and 20B).

The electrode assembly is pressurized and precharged (308).

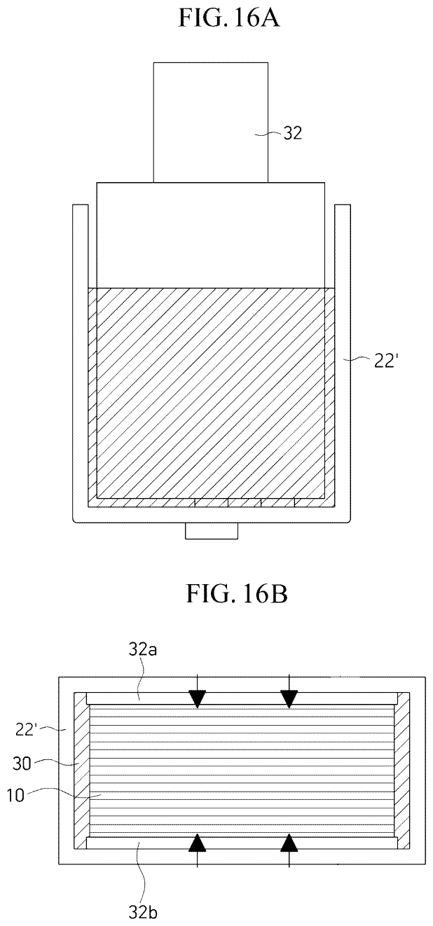

As shown in FIGS. 16A and 16B, a pressurization jig 32 may be inserted into a space between the battery can 22′ and the electrode assembly 10 accommodated in the battery can 22′ to pressurize in directions of arrows in FIG. 16B, thereby compressing the electrode plate surfaces. In this case, power may be supplied to the electrode assembly 10 to charge the electrode assembly 10 (precharging). When electricity is applied to the electrode assembly 10 to charge the electrode assembly 10, the electrode assembly 10 expands. Therefore, space between the electrode assembly 10 and an inner wall of the battery can 22′ is filled by the pressurization jig 32 so that the electrode plate surfaces may be pressurized due to the expansion of the electrode assembly 10. In another example, conversely, the pressurization jig 32 may be expanded to pressurize the electrode plate surfaces of the electrode assembly 10.

A pressurization area of the pressurization jig 32 may be large enough to cover the entire side area of the electrode assembly 10 (see FIG. 9B). This is to ensure that the electrode plates of the electrode assembly 10 can be pressurized uniformly. A pressurizing force of the pressurization jig 32 for compressing the electrode assembly 10 may be about 4 kgf to 13 kgf per unit area (e.g., per 1 cm²). That is, the electrode assembly 10 may be pressurized by the pressurizing force of about 4 kgf/cm² to 13 kgf/cm². However, the pressurizing force may vary.

After the pressurization and the precharging (308) are completed, the pressurization jig 32 may be separated and the cover 25 may be bonded onto the opening 27 of the battery can 22′ to seal the opening 27 (310).

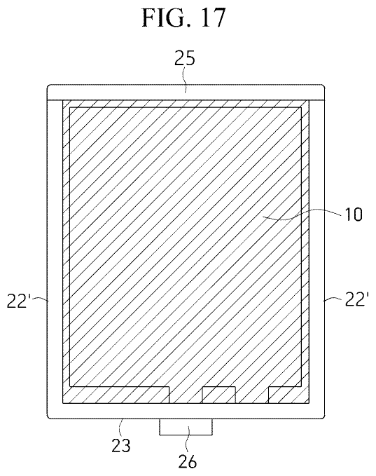

FIG. 17 shows a state in which the cover 25 is bonded onto the battery can 22′. The bonding of the cover 25 may be performed by laser welding, but method of bonding may vary. When necessary, after the welding, trimming for cutting and grinding an excess edge of the cover 25 may be required.

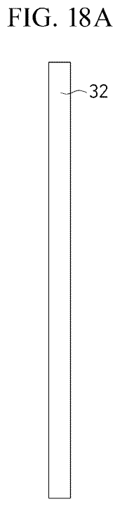

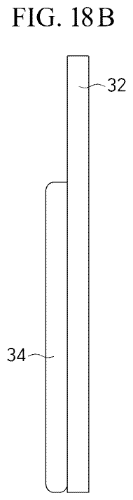

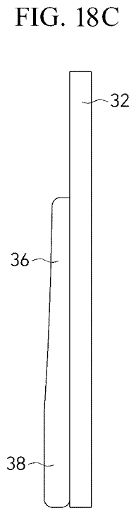

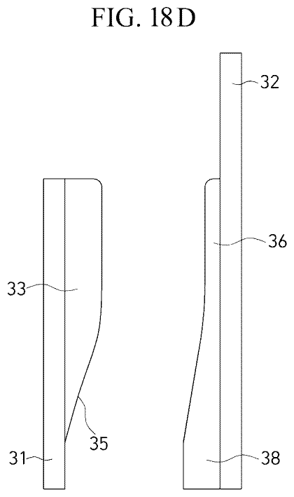

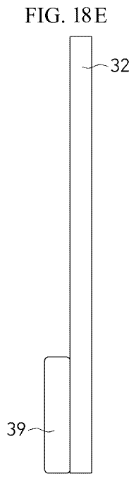

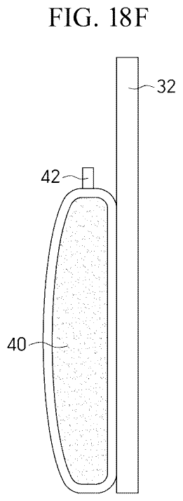

FIGS. 18A to 18F diagrams showing the pressurization jig 32 according to various embodiments.

FIG. 18A is a side view of the pressurization jig 32 shown in FIG. 16A. Basically, the pressurization jig 32 is a simple plate type that may be inserted into the space between the electrode plate surface of the electrode assembly 10 and the inner wall of the battery can 22′ as described above. Since an insertion space may vary depending on specifications of a secondary battery, the pressurization jig 32, which is plate-shaped may be used in one, two, three, or more by overlapping.

FIG. 18B is a side view of another type of a pressurization jig 32. According to the pressurization jig 32 according to the present embodiment, a protection pad 34 is attached to or formed integrally with a surface coming into contact with the electrode plate surface of the electrode assembly 10. The protection pad 34 is for preventing the electrode assembly 10 from being damaged due to pressurization of the pressurization jig 32 and maintaining flatness. The protection pad 34 may be made of silicone or Vulkollan to be attached to the pressurization jig 32. In another example, the protection pad 34 may be co-molded (e.g., insert injection molding, double injection molding, etc.) during the manufacture of the pressurization jig 32.

FIG. 18C is a side view of still another type of a pressurization jig 32. Even in the pressurization jig 32 according to the present embodiment, a contact pad may be attached to or formed integrally with a surface coming into contact with the electrode plate surface of the electrode assembly 10. However, in the present embodiment, the contact pad has different thicknesses according to positions on the electrode plate surface of the electrode assembly. That is, a first thickness portion 36 and a second thickness portion 38 that is thicker than the first thickness portion 36 constitute the contact pad. A thickness difference between the first thickness portion 36 and the second thickness portion 38 and outer shapes thereof may depend on a shape of the electrode plate surface of the electrode assembly 10.

FIG. 18D shows an example of the shape of the electrode plate surface of electrode assembly 10 (left) and the corresponding outer outline of the contact pad of pressurization jig 32 (right).

The electrode plate of electrode assembly 10 includes a region where a substrate is coated with an electrode material and an uncoated region (uncoated portion). Due to the nature of the process, when the electrode plate is manufactured, a gently (e.g., gradually) inclined region 35 is formed at a boundary between a coated region 33 of the substrate 31 and the uncoated portion where the electrode tab is formed, as shown at a left side of FIG. 18D. Since the electrode plate does not form a flat plate shape due to the inclined region 35, the pressurization jig 32 made of a flat plate cannot uniformly pressurize the entire surface of the electrode plate. Therefore, the contact pads having outlines and different thicknesses as shown in FIGS. 18C and 18D are attached to or integrally formed with the pressurization jig 32 so that a constant pressure is applied to the entire surface of the electrode plate.

FIG. 18E is a side view of yet another type of a pressurization jig 32. In the pressurization jig 32 according to this embodiment, a contact pad 39 is applied with a minimum area to apply a pressure only to the inclined region 35 of the electrode assembly 10 shown at the left side of FIG. 18D, thereby reducing a production cost.

FIG. 18F shows an embodiment of manufacturing a contact pad in the form of an expandable bag. The above pressurization jigs of FIGS. 18A to 18E are pressurization jigs in which the protection pad 34, the contact pad 39 and the first thickness portion 36 and the second thickness portion 38 are manufactured with the pre-designed thicknesses to apply a fixed pressurizing force, but the pressurization jig of FIG. 18F is a pressurization jig in which a thickness of a contact pad 40 changes depending on an amount of internally injected fluid to apply a variable pressurizing force. The fluid injected into the contact pad 40 (pocket-shaped) may be air, inert gas, aerofoam, other viscous liquids, etc., and may be injected and discharged through an inlet 42.

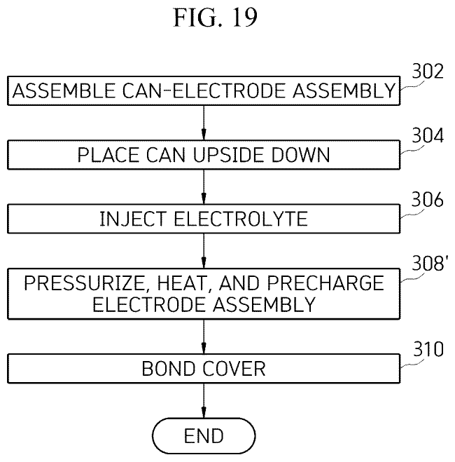

FIG. 19 is a process flowchart illustrating a method of manufacturing a secondary battery to which secondary battery precharging is applied according to some other embodiments of the present disclosure.

An operation of accommodating and assembling the electrode assembly 10 inside the battery can 22′ (302), an operation of placing the battery can upside down to allow the opening 27 to face upward (304), an operation of injecting an electrolyte (306), and an operation of bonding to a cover (310) may be performed in a similar manner to the embodiment of FIG. 13.

Unlike in FIG. 13, a modified process includes performing heating and also pressurizing the electrode assembly while performing the precharging of the electrode assembly (308′). By heating the electrode assembly, activation of the electrolyte and ions may be further promoted to further increase the bonding of the electrode plates and improve charging efficiency.

A heat source for heating the electrode assembly 10 may be included in the pressurization jig 32. In another example, a heating source of the electrode assembly 10 may be included in a support on which the battery can 22′ is mounted. In still another example, the heating source of the electrode assembly 10 may be a radiant heat source for directly emitting heat to the electrode assembly 10.

When the pressurizing force of the pressurization jig 32 for pressurizing the electrode assembly 10 ranges from about 4 kgf/cm² to 13 kgf/cm², which is the same condition as in the previous case, a heating temperature may range from 0° C. to about 110° C.

FIGS. 20A and 20B are process flowcharts illustrating a method of manufacturing a secondary battery to which secondary battery precharging is applied according to still other embodiments of the present disclosure.

In this case, as described above, an operation of additionally injecting the electrolyte 30 into the battery can 22′ (309) may be included after the pressurizing and the precharging are performed.

In the case of FIG. 20A, the operation of additionally injecting an electrolyte (309) may be performed after the pressurizing and the precharging of the electrode assembly (308). Since the operation of additionally injecting the electrolyte (309) is performed before the bonding of the cover (310), the electrolyte may be injected into the opening 27 of the battery can 22′, but this may vary. For example, when the electrolyte inlet 28 is formed in the battery can 22′ as shown FIG. 12B, the electrolyte may be added additionally through the electrolyte inlet 28.

In the case of FIG. 20B, since the operation of additionally injecting the electrolyte (309) is performed after the bonding of the cover (310), the electrolyte may be additionally injected through the electrolyte inlet 28 as shown in FIG. 3B.

FIG. 21 is an exemplary diagram illustrating a secondary battery module in which the secondary batteries (see FIGS. 3A and 3B, and FIGS. 12A and 12B) employing the electrode assembly manufactured according to the present disclosure are disposed. In accordance with an increase in secondary battery capacity for driving electric vehicles, a secondary battery module is manufactured by arranging and connecting a plurality of secondary battery cells in a lateral and/or vertical direction. A plurality of secondary batteries may be disposed in a space formed by a pair of end plates 68a and 68b facing each other and a pair of side plates 69a and 69b facing each other. The arrangement (e.g., and the number) of the secondary batteries may be designed to achieve desired voltage and current specifications.

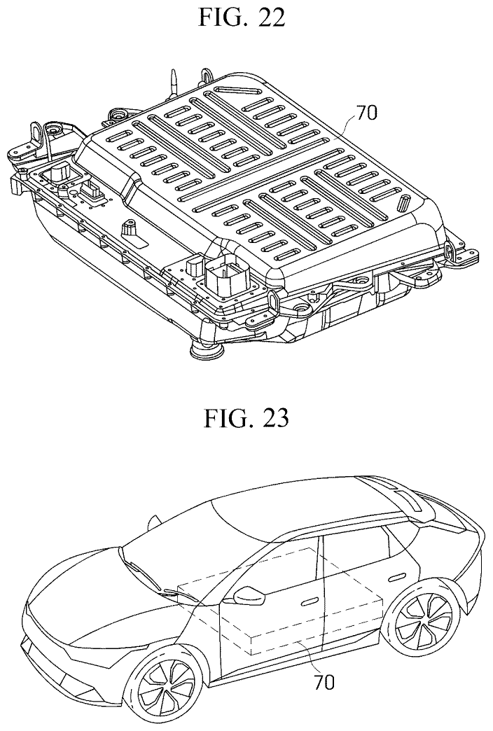

FIG. 22 is an exemplary diagram illustrating a secondary battery pack 70 formed to apply the secondary battery module shown in FIG. 21 to an actual product (e.g., a vehicle). The secondary battery pack may be manufactured by embedding a plurality of secondary battery modules into a pack housing designed to be mounted in an actual product. The pack housing may include fasteners and electrical outlets necessary for being mounted in the product. In FIG. 21, for convenience of illustration, related elements such as bus bars for electrical connection of the secondary batteries, cooling units, and external terminals are omitted.

The secondary battery pack may be mounted in a vehicle. The vehicle may be, for example, an electric vehicle, a hybrid vehicle, or a plug-in hybrid vehicle. The vehicle may include a four-wheel drive or two-wheel drive vehicle. FIG. 23 is a diagram for describing a vehicle including the secondary battery pack shown in FIG. 22. FIG. 23 illustrates the secondary battery pack 70 according to one embodiment of the present disclosure mounted on a lower portion of a vehicle body of a vehicle. The vehicle operates by receiving power from the secondary battery pack 70 according to one embodiment of the present disclosure.

When a secondary battery is manufactured, a process is carried out in which an electrode assembly is accommodated in a battery can, the electrode assembly and an external terminal are electrically connected, an electrolyte is injected, and subsequently the electrode assembly is precharged. In this process, there occurs a problem of a local charging malfunction due to lifting or insufficient bonding of electrode plates constituting the electrode assembly immersed in the electrolyte and side reactions due to the local charging malfunction. In addition, since a thickness of the electrode assembly may increase, there may be a limitation to an energy density capable of being obtained within a given battery can space.

The present disclosure is directed to providing a method of simultaneously performing pressing of electrode plates while precharging an electrode assembly.

According to the present disclosure, pressurizing and precharging can be performed even when a battery can for accommodating an electrode assembly is made of a rigid material (a metal, synthetic resin, etc.), thereby resolving a local charging malfunction and side reactions which occur while performing conventional precharging.

In addition, thickness control is made possible through bonding of electrode plates of the electrode assembly, enabling increased energy density and a compact size.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of manufacturing a secondary battery, the method comprising:
providing a battery can with an opening and a terminal-side surface, the terminal-side surface including a terminal;
providing a cover, the cover being bonded onto the opening of the battery can;
assembling an electrode assembly;
accommodating the electrode assembly in the battery can and mounting the same, such that the electrode assembly faces the opening;
injecting an electrolyte into the battery can within which the electrode assembly is accommodated;
pressurizing and precharging the electrode assembly; and
bonding the cover onto the opening of the battery can.

2. The method as claimed in claim 1, wherein providing the battery can comprises forming the opening at a surface orthogonal to the terminal-side surface of the battery can.

3. The method as claimed in claim 1, wherein providing the battery can comprises forming the opening opposite to the terminal-side surface of the battery can.

4. The method as claimed in claim 1, wherein injecting the electrolyte comprises injecting the electrolyte through the opening of the battery can.

5. The method as claimed in claim 2, wherein:
providing the battery can comprises forming an electrolyte inlet in the battery can, and
injecting the electrolyte comprises injecting the electrolyte through the electrolyte inlet of the battery can.

6. The method as claimed in claim 5, further comprising, after bonding the cover onto the opening of the battery can, additionally injecting an electrolyte through the electrolyte inlet formed in the battery can.

7. The method as claimed in claim 1, wherein pressurizing and precharging the electrode assembly comprises pressurizing, by a pressurization jig, the electrode assembly exposed through the opening while charging the electrode assembly accommodated in the battery can by supplying power.

8. The method as claimed in claim 7, wherein the pressurization jig is configured to downward pressurize the electrode assembly horizontally placed.

9. The method as claimed in claim 7, further comprising inserting the pressurization jig into a space between the electrode assembly and the battery can.

10. The method as claimed in claim 7, wherein the pressurization jig comprises a protection pad attached to a surface in contact with the electrode assembly.

11. The method as claimed in claim 10, wherein the protection pad has different thicknesses according to positions on an electrode plate of the electrode assembly.

12. The method as claimed in claim 10, further comprising injecting a fluid to expand the protection pad.

13. The method as claimed in claim 1, wherein pressurizing and precharging the electrode assembly comprises heating the electrode assembly.

14. The method as claimed in claim 1, further comprising, after pressurizing and precharging the electrode assembly, additionally injecting an electrolyte into the battery can.

15. A method of precharging a secondary battery, the method comprising:
providing an electrode assembly;
providing a battery can with an opening and accommodating the electrode assembly in the battery can, the electrode assembly facing the opening;
injecting an electrolyte into the battery can with the electrode assembly accommodated in the battery can; and
pressurizing and precharging the electrode assembly.

16. The method as claimed in claim 15, wherein pressurizing and precharging the electrode assembly comprises pressurizing, by a pressurization jig, the electrode assembly exposed through the opening while charging the electrode assembly accommodated in the battery can by supplying power.

17. The method as claimed in claim 15, wherein pressurizing and precharging the electrode assembly comprises heating the electrode assembly.

18. A secondary battery manufactured by the method of manufacturing as claimed in claim 1, the secondary battery comprising:
the battery can with an opening and the terminal-side surface, a terminal being on the terminal-side surface, the electrode assembly being accommodated in the battery can; and
the cover being bonded onto the opening of the battery can.

19. A secondary battery as claimed in claim 18, wherein the opening is at a surface orthogonal to the terminal-side surface of the battery can.

20. The secondary battery as claimed in claim 18, wherein the opening is opposite to the terminal-side surface of the battery can.
